(19) United States
(12) Patent Application Publication
(10) Pub. No.: US 2014/0071176 A1
(43) Pub. Date: Mar. 13, 2014

(54) ORGANIC LIGHT EMITTING DISPLAY DEVICE AND DRIVING METHOD THEREOF

(71) Applicant: SAMSUNG DISPLAY CO., LTD., Yongin-City (KR)

(72) Inventor: Yang-Wan KIM, Yongin-City (KR)

(73) Assignee: SAMSUNG DISPLAY CO., LTD., Yongin-City (KR)

(21) Appl. No.: 13/773,727

(22) Filed: Feb. 22, 2013

(30) Foreign Application Priority Data
Sep. 11, 2012 (KR) 10-2012-0100606

(51) Int. Cl. G09G 3/00

(52) U.S. Cl. CPC G09G 3/001
USPC 345/690; 345/211; 345/213; 345/212

(57) ABSTRACT

An organic light emitting display device capable of improving image quality. A driving method of an organic light emitting display device in which a plurality of sub-fields may be included in one frame, wherein a first sub-field includes an initialization period in which voltage of an initialization power supply is supplied to a gate electrode of a driving transistor included in each of the pixels, a scan period that voltage corresponding to a data signal is stored in the pixels, and a light emitting period that the pixels emit light, and wherein the remaining sub-fields with the exception of the first sub-field include only a scan period and a light emitting period.

### CLAIM OF PRIORITY

This application makes reference to, incorporates the same herein, and claims all benefits accruing under 35 U.S.C. §119 from an application earlier filed in the Korean Intellectual Property Office on the 11^{th} of September 2012 and there duly assigned Serial No. 10-2012-0100606.

### BACKGROUND OF THE INVENTION

1. Field of the Invention

The present invention relates to an organic light emitting display device and a driving method thereof, and more particularly, to an organic light emitting display device capable of improving display quality and a driving method thereof.

2. Description of the Related Art

Recently, various flat panel displays capable of reducing weight and volume, which are disadvantages of a cathode ray tube have been developed. As to flat panel displays, there are a liquid crystal display, a field emission display, a plasma display panel, an organic light emitting display device, and the like.

Among the flat panel displays, the organic light emitting display device, which displays an image using an organic light emitting diode generating light by recombination between an electron and a hole, has advantages in that it has a rapid response speed and is driven at low power.

However, in an organic light emitting display device according to the related art, a blur is observed at a low brightness area. More specifically, the organic light emitting display device compensates for a threshold voltage of a driving transistor included in each of the pixels in view of a circuit. However, the threshold voltage is not appropriately compensated for due to a low current at a low brightness area, such that a blur, or the like, is observed.

### SUMMARY OF THE INVENTION

An object to the present invention is to provide an organic light emitting display device capable of improving display quality, and a driving method thereof.

A driving method of an organic light emitting display device in which a plurality of sub-fields may be included in one frame, wherein a first sub-field includes an initialization period in which voltage of an initialization power supply is supplied to a gate electrode of a driving transistor included in each of the pixels, a scan period that voltage corresponding to a data signal is stored in the pixels, and a light emitting period that the pixels emit light, and wherein the remaining sub-fields with the exception of the first sub-field include only a scan period and a light emitting period.

Data signals supplied in an i^{th} (i indicates a natural number) may be set to be lower voltage than those of data signals supplied in an i^{th}−1 sub-field. A pixel set to be in a non-light emitting state in an i^{th} sub-field (i indicates a natural number) may be also set to be in the non-light emitting state in a sub-field after the i^{th} sub-field. A pixel emitting the light in j+1 sub-fields may implement a grayscale higher than that of a pixel emitting the light in j sub-fields (j indicates a natural number). The light emitting periods of each of the sub-fields are set to be different. A light emitting period of an i^{th} sub-field (i indicates a natural number) is set to be longer than that of an i^{th}−1 sub-field. The data signals supplied to the sub-fields may be set so that a plurality of grayscales are implemented in each of the sub-fields. The voltage of the initialization power supply may be set to be lower than that of the data signal.

An organic light emitting display device driven in each of the sub-fields divided from one frame, the organic light emitting display device comprising: a scan driving unit supplying scan signals to scan lines and light emitting control signals to light emitting control lines, respectively in each of the sub-fields; a control driving unit supplying the control signals to the control lines only during a first sub-field period of one frame; a data driving unit supplying data signals to data lines so as to be synchronized with the scan signals in each of the sub-field; and pixels positioned at intersection portions between the scan lines and the data lines.

The data driving unit may supply a data signal having voltage higher than that of a data signal supplied in an i^{th} sub-field (i indicates a natural number) during an i^{th}−1 sub-field period. Light emitting periods in which the pixels emit light may be set to be different in each of the sub-fields. A light emitting period of an i^{th} sub-field (i indicates a natural number) is set to be longer than that of an i^{th}−1 sub-field. The control driving unit may supply the control signal to an i^{th} control line before the scan signal is supplied to an i^{th} scan line (i indicates a natural number). The scan driving unit may supply the light emitting control signal to the i^{th} light emitting control line so as to be overlapped with the scan signal supplied to the i^{th} scan line and the control signal supplied to the i^{th} control line.

Each of the pixels positioned at an i^{th} horizontal line including: an organic light emitting diode; a first transistor controlling an amount of current flowing from a first power supply connected to a first electrode thereof to a second power supply via the organic light emitting diode, corresponding to voltage applied to a first node; a second transistor connected between the first node and an initializing power supply and turned on when the control signal is supplied to the i^{th} control line; a third transistor connected between the data line and the first electrode of the first transistor and turned on when the scan signal is supplied to the i^{th} scan line; and a fourth transistor connected between a second electrode of the first transistor and the first node and turned on when the scan signal is supplied to the i^{th} scan line.

Each of the pixels positioned at the i^{th} horizontal line further includes: a fifth transistor connected between the first electrode of the first transistor and the first power supply, and turned off when the light emitting control signal is supplied to the i^{th} light emitting control line and turned on in other cases; and a sixth transistor connected between the second electrode of the first transistor and the organic light emitting display diode and turned off when the light emitting control signal is supplied to the i^{th} light emitting control line and turned on in other cases.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a view showing an organic light emitting display device according to an exemplary embodiment of the present invention;

FIG. 2 is a circuit diagram showing a pixel according to the exemplary embodiment of the present invention;

FIG. 3 is a waveform diagram showing a driving method of the pixel shown in FIG. 2;

FIG. 4 is a view showing one frame period of the organic light emitting display device according to the exemplary embodiment of the present invention;

FIG. 5 is a view schematically showing driving waveforms supplied in a sub-field; and

FIG. 6 is a view showing an example of implementation of a grayscale.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

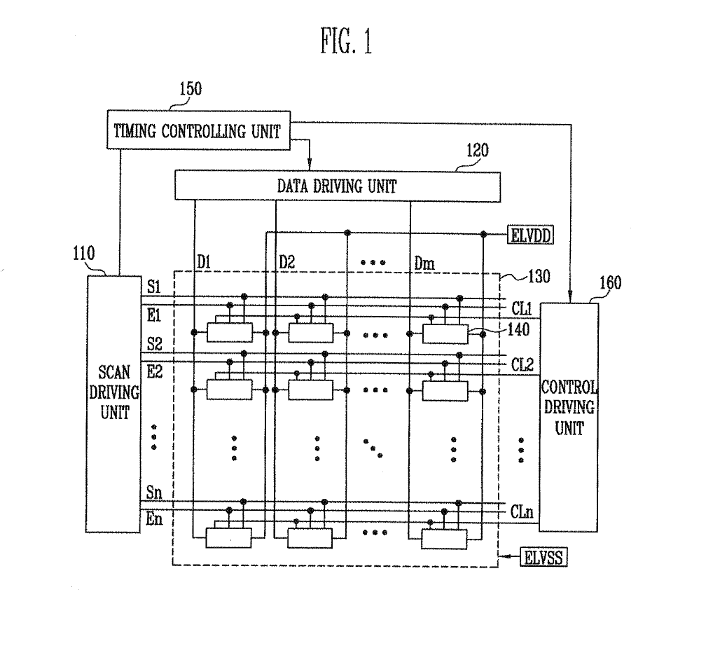

Hereinafter, exemplary embodiments of the present invention that may be easily practiced by those skilled in the art to which the present invention pertains will be described in detail with reference to FIGS. 1 to 6.

FIG. 1 is a view showing an organic light emitting display device according to an exemplary embodiment of the present invention.

Referring to FIG. 1, the organic light emitting display device according to the exemplary embodiment of the present invention includes a pixel unit 130 including pixels 140 positioned at intersection portions between scan lines S1 to Sn and data lines D1 to Dm, a scan driving unit 110 driving the scan lines S1 to Sn and light emitting control lines E1 to En, a data driving unit 120 driving the data lines D1 to Dm, a control driving unit 160 driving control lines CL1 to CLn, and a timing controlling unit 150 controlling the scan driving unit 110, the data driving unit 150, and the control driving unit 160.

The timing controlling unit 150 controls the scan driving unit 110, the data driving unit 120, and the control driving unit 160 according to synchronization signals supplied from outside. Also, the timing controlling unit 150 rearranges the data supplied from outside and supplies the rearranged data to the data driving unit 120.

The scan driving unit 110 generates the scan signals and sequentially supplies the generated scan signals to the scan lines S1 to Sn. Here, the scan signals are supplied in a first direction (for example, an order from the first scan line S1 to the n^{th} scan line Sn) or a second direction (for example, the n^{th} scan line Sn to the first scan line S1) according to the driving method. Also, the scan driving unit 110 generates the light emitting control signals and sequentially supplies the generated light emitting control signals to the light emitting control lines E1 to En. Here, the light emitting control signals are supplied in the same direction as the direction in which the scan signals are supplied. For example, in the case in which the scan signal is supplied in the first direction, the light emitting control signal is also supplied in the first direction, and in the case in which the scan signal supplied in the second direction, the light emitting control signal is also supplied in the second direction. Meanwhile, in the exemplary embodiment of the present invention, one frame is divided into a plurality of sub-fields, and the scan signal and the light emitting control signal are supplied in each of the scan periods of the sub-fields.

Additionally, a width of the light emitting control signal is set to be equal to or wider than that of the scan signal. For example, the light emitting control signal supplied to an i^{th} light emitting control line Ei (i indicates a natural number) is supplied so as to be overlapped with the control signal supplied to an i^{th} control line CLi and the scan signal supplied to an i^{th} scan line Si. A detailed description thereof will be provided with respect to FIG. 3.

The control driving unit 160 generates the control signals and sequentially supplies the generated control signals to the control lines (CL1 to CLn). Here, the control signals are supplied in the same direction as the direction in which the scan signals are supplied. For example, in the case in which the scan signal is supplied in the first direction, the control signal is also supplied in the first direction, and in the case in which the scan signal is supplied in the second direction, the control signal is also supplied in the second direction.

Also, the control signal supplied to the i^{th} control line CLi is supplied to the i^{th} control line CLi before the scan signal is supplied to the i^{th} scan line Si, so as not to be overlapped with the scan signal supplied to the i^{th} scan line Si. As an example, the control signal supplied to the i^{th} control line CLi may be supplied so as to be overlapped with the scan signal supplied before the i^{th} scan line Si, for example, the scan signal supplied to the i^{th}−1 scan line.

Meanwhile, according to the exemplary embodiment of the present invention, the control signals supplied to the control lines CL1 to CLn are supplied only in a scan period (or an initialization period) of a first sub-field among the plurality of sub-fields included in the frame. A detailed description thereof will be provided below.

The data driving unit 120 receives the rearranged data from timing controlling unit 150 and generates the data signals and supplies the generated data signals to the data lines D1 to Dm so as to be synchronized with the scan signals.

The pixel unit 130 receives a first power ELVDD and a second power ELVSS from outside and supplies them to each of the pixels 140. Here, when the control signals are supplied to the control lines CL1 to CLn, gate electrodes of driving transistors included in each of the pixels 140 are initialized, and when the scan signals are supplied to the scan lines S1 to Sn, voltages corresponding to the data signals are stored in the pixels 140. The pixels 140 in which the voltage corresponding to the data signal are stored generate light according to an amount of current flowing from the first power supply ELVDD to the second power supply ELVSS via an organic light emitting diode (not shown), corresponding to the data signals to generate light having predetermined luminance.

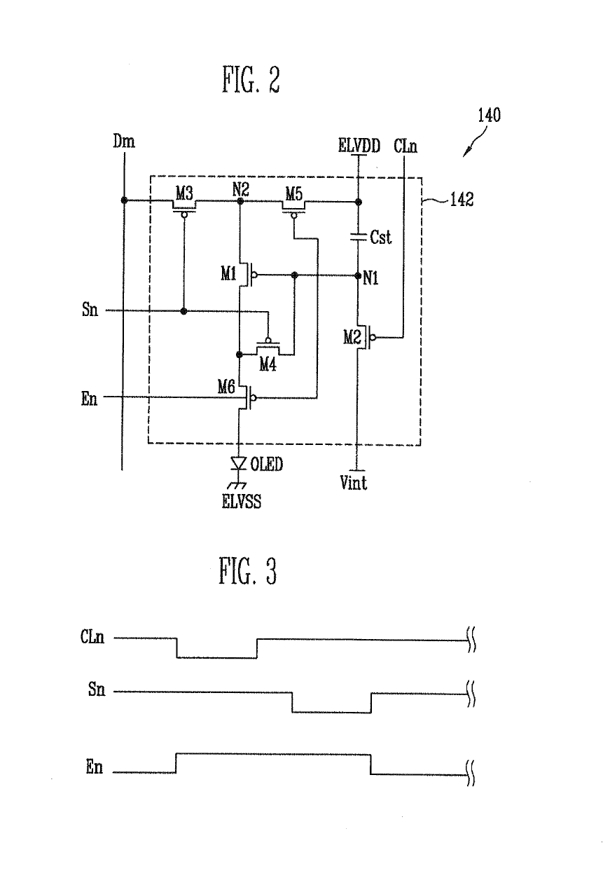

FIG. 2 is a circuit view showing a pixel according to the exemplary embodiment of the present invention. In the FIG. 2, the pixel connected to an m^{th} data line Dm and an n^{th} scan line Sn will be shown for convenience of explanation.

Referring to FIG. 2, the pixel 140 according to the exemplary embodiment of the present invention includes an organic light emitting diode (OLED) and a pixel circuit 142 connected to the data line Dm, the scan line Sn, and the light emitting control line En to control an amount of current supplied to the OLED.

An anode electrode of the OLED is connected to the pixel circuit 142, and a cathode electrode thereof is connected to the second power supply ELVSS. Here, voltage of the second power supply ELVSS is set to be lower than that of the first power supply ELVDD. The organic light emitting diode (OLED) as described above generates light having predetermined luminance, corresponding to an amount of current supplied from the pixel circuit 142.

The pixel circuit 142 is initialized when the control signal is supplied to the control line CLn and stores a voltage corresponding to the data signal therein when the scan signal is supplied to the scan line Sn. Further, the pixel circuit 142 controls an amount of current supplied to the organic light diode (OLED), corresponding to the stored voltage. To this end, the pixel circuit 142 includes first to six transistors M1 to M6 and a storage capacitor Cst.

A first electrode of the first transistor M1 is connected to a second node N2, and a second electrode thereof is connected to a first electrode of the sixth transistor M6. In addition, a gate electrode of the first transistor M1 is connected to a first node N1. The first transistor M1 as described above supplies the current corresponding to the voltage charged in the storage capacitor Cst to the organic light emitting diode OLED. Accordingly, first transistor M1 is a drive transistor.

A first electrode of the second transistor M2 is connected to the first node N1, and the second electrode thereof is connected to an initialization power supply Vint. Further, a gate electrode of the second transistor M2 is connected to the control line CLn. The second transistor M2 as described above is turned on when the control signal is supplied to the control line CLn, thereby supplying the voltage of the initialization power supply Vint to the first node N1. Here, the initialization power Vint is set to voltage lower than that of the data signal.

A first electrode of the third transistor M3 is connected to the data line Dm, a second electrode thereof is connected to the second node N2 and a gate electrode thereof is connected to the scan line Sn. The third transistor M3 as described above is turned on when the scan signal is supplied to scan line Sn. Accordingly, third transistor M3 is a switching transistor.

In addition, a gate electrode of the third transistor M3 is connected to the scan line Sn. The third transistor M3 as described above is turned on when the scan signal is supplied to the scan line Sn, thereby supplying the data signal from the data line Dm to the second node N2.

A first electrode of the forth transistor M4 is connected to a second electrode of the first transistor M1, and a second electrode thereof is connected to the first node N1. In addition, a gate electrode of the forth transistor M4 is also connected to the scan line Sn. The forth transistor M4 as described above is turned on when the scan signal is supplied to scan line Sn, thereby connecting the first transistor M1 in a diode form.

A first electrode of the fifth transistor M5 is connected to the first power supply ELVDD, a second electrode thereof is connected to the second node N2 and a gate electrode thereof is connected to the light emitting control line En. The fifth transistor M5 is turned off when the light emitting control signal is supplied to the light emitting control line En, and is turned on when the light emitting control signal is not supplied thereto.

A first electrode of the sixth transistor M6 is connected to the second electrode of the first transistor M1, a second electrode thereof is connected to an anode electrode of the organic light emitting diode OLED and a gate electrode thereof is connected to the light emitting control line En. The sixth transistor M6 is turned off when the light emitting control signal is supplied to the light emitting control line En, and turned on when the light emitting control signal is not supplied thereto.

FIG. 3 is a waveform diagram showing a driving method of a pixel shown in FIG. 2. FIG. 3 show wave forms supplied in the first sub-field for convenience of explanation.

Referring to FIG. 3, first, the light emitting control signal is supplied to the light emitting control line En, such that the fifth transistor M5 and the sixth transistor M6 are turned off. In the case in which the fifth transistor M5 is turned off, the first power supply ELVDD and the second node N2 are electrically blocked. In the case in which the sixth transistor M6 is turned off, the first transistor M1 and the organic light emitting diode OLDE are electrically blocked. That is, the pixel 140 is set to be in a non-light emitting state in a period in which the light emitting control signal is supplied.

Additionally, the control signal is supplied to the control line CLn. When the control signal is supplied to the control line CLn, the second transistor M2 is turned on. When the second transistor M2 is turned on, the voltage of the initialization power Vint is supplied to the first node N1.

After the voltage of the initialization power Vint is supplied to the first node N1, the scan signal is supplied to the scan line Sn, such that the third transistor M3 and the fourth transistor M4 are turned on.

When the forth transistor M4 is turned on, the first transistor M1 becomes a diode-connected transistor. When the third transistor M3 is turned on, the data signal from the data line Dm is supplied to the second node N2. In this case, since the first node N1 is initialized to the voltage of the initialization power Vint, which is voltage lower than that of the second node N2, the first transistor M1 is turned on. In this case, voltage generated by subtracting a threshold voltage of the first transistor M1 from the voltage of the data signal applied to the second node N2 is applied to the first node N1. The storage capacitor Cst stores the voltage supplied to the first node N1 therein.

After a predetermined voltage is charged in the storage capacitor Cst, the supply of the light emitting control signal to the light emitting control line En is stopped, such that the fifth and sixth transistors M5 and M6 are turned on. When the fifth and sixth transistors M5 and M6 are turned on, a current path from the first power supply ELVDD to the second power supply ELVSS via the organic light emitting diode is formed. In this case, the first transistor M1 controls an amount of current flowing from the first power supply ELVDD to the organic light emitting diode OLED, corresponding to the voltage charged in the storage capacitor Cst.

Actually, the pixels 140 according to the exemplary embodiment of the present invention are driven as described above during the first sub-field period to generate light having predetermined luminance. Meanwhile, in the exemplary embodiment of the present invention, the control signal is not supplied to the control line CLn during the remaining periods with the exception of the first sub-field included in one frame. A detailed description thereof will be provided below.

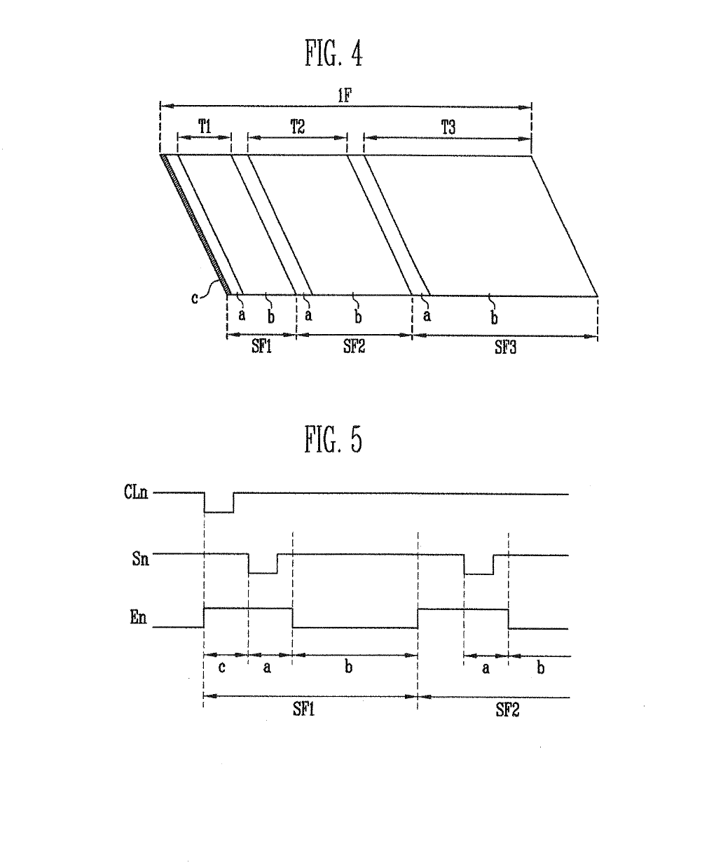

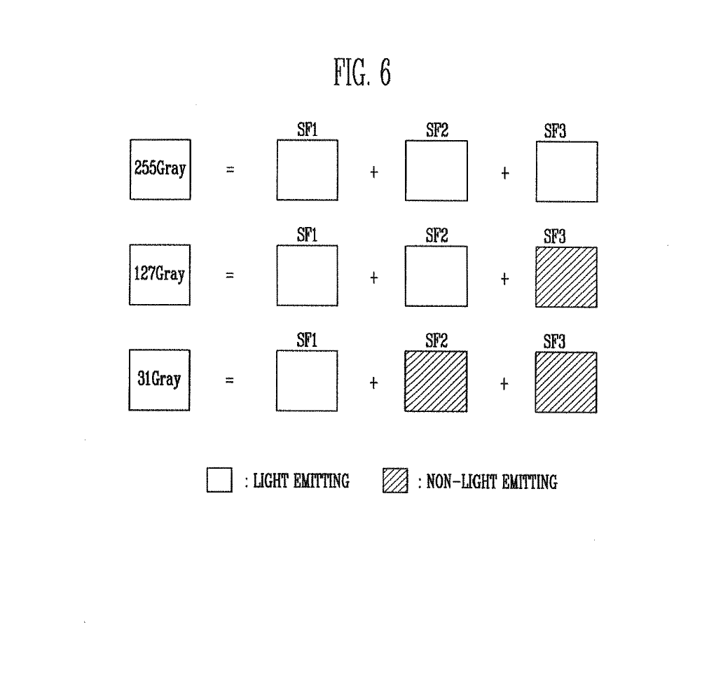

FIG. 4 is a view showing one frame period of the organic light emitting display device according to the exemplary embodiment of the present invention. FIG. 5 is a view schematically showing driving waveforms supplied in a sub-field period. Although the case in which one frame is divided into three sub-field SF1 to SF3 is shown in FIG. 3, the present invention is not limited thereto.

Referring to FIG. 4 and FIG. 5, a frame 1F of the organic light emitting display device according to the exemplary embodiment of the present invention is divided into a plurality of sub-fields SF1 to SF3. Here, the first sub-field SF1 is divided into an initialization period “c” in which the control signals are supplied to the control lines CL1 to CLn, a scan period “a” in which the scan signals are supplied to the scan lines S1 to Sn, and a light emitting period “b” in which the pixels 140 emit the light. Further, the remaining sub-fields SF2 and SF3 with the exception of the first sub-field SF1 are divided into the scan period “a” in which the scan signals are supplied to the scan lines S1 to Sn and the light emitting period “b” in which the pixels 140 emit the light.

In the initialization period “c”, the control signals are supplied to the control lines CL1 to CLn, such that the initialization power Vint is supplied to the first node N1 of each of the pixels 140. In the scan period “a”, the scan signals are supplied to the scan lines S1 to Sn, such that the voltage corresponding to the data signal is charged in each of the pixels 140.

In the light emitting period “b”, the light having predetermined luminance is generated, corresponding to the charged voltage in each of the pixels 140. Here, during the light emitting period “b”, each of the pixels 140 generates light having same luminance or different luminances, corresponding to the data signal.

Meanwhile, in the case of implementing a grayscale in the present invention, the pixel 140 emits the light in an order of the first sub-field SF1, the second sub-field SF2, and the third sub field SF3. In other words, in the case in which a predetermined grayscale is implemented in a specific pixel, the pixel is set to be in a light emitting state in the first sub-field SF1.

Here, in the case in which the predetermined grayscale is implemented in the first sub-field SF1, the remaining sub-fields are set to be in a non-light emitting state. On the other hand, in the case in which the predetermined grayscale is not implemented in the first sub-field SF1, the second sub-field SF2 is set to be in a light emitting state. Further, in the case in which the predetermined grayscale is implemented in the second sub-field SF2, the remaining sub-fields are set to be in a non-light emitting state. On the other hand, in the case in which the predetermined grayscale is not implemented in the second sub-field SF2, the third sub-field SF3 is set to be in a light emitting state.

That is, according to the exemplary embodiment of the present invention, the light is sequentially emitted in an order from the first sub-field SF1 to the last sub-field, for example, a j^{th} sub-field (j indicates a natural number) to implement a predetermined grayscale. In the case in which the light is not emitted in a j^{th}−1 sub-field, the j^{th} sub-filed is unconditionally set to be in the non-light emitting state.

Additionally, according to the exemplary embodiment of the present invention, the light emitting periods of each of the sub-fields SF1 to SF3 is set to be different. For example, a light emitting period of the j^{th} sub-field period is set to be longer than that of the j^{th}−1 sub-field. For example, in the case in which the light emitting period of the first sub-field SF1 is set to a first period T1, a light emitting period of the second sub-field SF2 is set to a second period T2 longer than the first period T1. Also, a light emitting period of the third sub-field SF3 is set to a third period T3 longer than the second period T2.

In the case in which the light emitting period of the j^{th} sub-field is set to be longer than that of the j^{th}−1 sub-field as described above, high current flows in the pixel displaying a low grayscale, thereby making it possible to implement low grayscale luminance while stably compensating for the threshold voltage. In addition, in the case in which the high grayscale is displayed, since the pixel emits the light during sufficient long period, deterioration of a lifespan due to an increase of current may be prevented.

Describing an operation process in more detail, as shown in FIG. 6, pixels implementing low grayscales, for example, grayscales of 1 to 63 emit the light only in the first sub-field SF1 period. To this end, during the scan period of the first sub-field SF1, data signals corresponding to the grayscales of 1 to 63 are supplied to each of the pixels.

The pixel implementing the low grayscale emits the light in the first sub-field SF1 period and is set to be in the non-light emitting state during the second sub-field SF2 and the third sub-field SF3. Therefore, the pixel displaying the low grayscale during the first sub-field SF1 period is set to generate high luminance light during a short time. In this case, higher current flows in the pixel implementing the low grayscale as compared with the related art during the first sub-field SF1, thereby making it possible to stably compensate for the threshold voltage of the driving transistor.

In other words, according to the related art, the pixel implementing a grayscale of 31 emits the light, corresponding to low current during one frame period. On the other hand, according to the exemplary embodiment of the present invention, the pixel implementing a grayscale of 31 emits the light corresponding to high current so as to implement the grayscale of 31 during the first period T1. In the case in which the high current flows in the pixel as described above, the threshold voltage of the driving transistor is stably compensated for, thereby making it possible to improve display quality in the low grayscale region.

Additionally, a first data signal having a predetermined voltage range is supplied so that the high current may be supplied to the pixels 140 during the first sub-field SF1 period. Here, the first data signals are set to low voltage so that the high current may flow in the pixels 140.

In the exemplary embodiment of the present invention, the pixels implementing an intermediate grayscale, for example, grayscales of 64 to 127, emit the light only during the first sub-field SF1 period and the second sub-field SF2 period. In this case, the data signals corresponding to the grayscale of 63 are supplied to each of the pixels during the scan period of the first sub-field period SF1, and the data signals corresponding to the grayscales of 1 to 64 are supplied to each of the pixels during the scan period of the second sub-field period SF2.

As an example, a specific pixel implementing a grayscale of 127 is supplied with the data signal corresponding to the grayscale of 63 during the first sub-field period SH and the data signal corresponding to the grayscale of 64 during the second sub-field period SF2. In this case, the grayscale of 127 is implemented in the specific pixel by the sum of light emitting periods of the first sub-field SF1 and the second sub-field SF2.

Here, the second period T2 of the second sub-field SF2 is set to be longer than that of the first period T1. Therefore, a second data signal having a range of voltage higher than that of the first data signal is supplied during the second sub-field period in order to implement a desired grayscale. That is, the second data signal supplied during the second sub-field period SF2 is set to have voltage higher than the first data signal supplied during the first sub-field period SF1.

Therefore, during the second sub-field period SF2, even though the initialization period c is omitted, the pixels 140 may be stably driven. In other words, the voltage applied to the second nodes N2 of each of the pixels 140 during the second sub-field period SF2 is set to be higher than the voltage applied to the first node N1, such that the storage capacitor Cst may be stably charged with desired voltage.

Meanwhile, during the remaining sub-field periods SF2 and SF3 with the exception of the first sub-field, in the case in which the initialization period “c” is omitted, power according to the initialization is reduced, such that power consumption may be minimized.

The pixels implementing high grayscales, for example, grayscales of 128 to 255, emit the light during the first sub-field SF1 period to the third sub-field SF3 period. In this case, each of the pixels implementing the high grayscale is supplied with the data signals corresponding to the grayscale of 63 during the scan period of the first sub-field SF1, the grayscale of 64 during the scan period of the second sub-field SF2, and the grayscales of 1 to 128 during the scan period of the third sub-field SF3.

As an example, a specific pixel implementing the grayscale of 255 is supplied with the data signal corresponding to the grayscale of 63 during the first sub-field period SF1, the grayscale of 64 during the second sub-field period SF2, and the grayscale of 128 during the third sub-field period SF3. Meanwhile, in the exemplary embodiment of the present invention, the light is emitted during one frame period in a high grayscale region. Therefore, the current is not increased in implementing the high grayscale region, as compared with the case according to the related art.

Meanwhile, the third period T3 of the third sub-field SF3 is set to be longer than the second period T2. Therefore, in order to implement a desired grayscale, a third data signal having a range of voltage higher than that of the second data signal during the third sub-field period is supplied. That is, the third data signal supplied during the third sub-field period SF3 is set to have voltage higher than that of the second data signal supplied during the second sub-field period SF2.

In this case, during the third sub-field period SF3, even though the initialization period “c” is omitted, the pixels 140 may be stably driven. In other words, the voltage applied to the second nodes N2 of each of the pixels 140 is set to be higher than the voltage applied to the first node N1 during the third sub-field period SF3, such that the storage capacitor Cst may be stably charged with the desired voltage.

With the organic light emitting display device and the driving method thereof according to the exemplary embodiments of the present invention, the organic light emitting display device is driven in each of the sub-fields divided from one frame. Here, a pixel implementing a low grayscale is set to be in the light emitting state during one sub-field period. In this case, the pixel implementing the low grayscale is driven corresponded to high current in order to implement the grayscale for a short time, thereby making it possible to display an image in which the threshold voltage is compensated for.

Also, according to the exemplary embodiments of the present invention, the gate electrode of the driving transistor is initialized to the voltage of the initialization power supply during the first sub-field period. In this case, power consumption of the driving transistor due to initialization of the driving transistor may be minimized.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A driving method of pixels in an organic light emitting display device, wherein a plurality of sub-fields are included in one frame period, the method comprising:
supplying a voltage of an initialization power supply to a gate electrode of a driving transistor included in each of the pixels during an initialization period of a first sub-field;
supplying a voltage of a data signal during a scan period of each sub-field, the voltage being stored in the pixels;
emitting light corresponding to the stored voltage during a light emitting period of each sub-field, wherein only the first sub-field includes the initialization period.

2. The driving method according to claim 1, wherein the voltage of data signals supplied in an i^{th} sub-field (i indicates a natural number) are set to be lower than the voltage of data signals supplied in an i^{th}−1 sub-field.

3. The driving method according to claim 1, wherein a pixel set to be in a non-light emitting state in an i^{th} sub-field (i indicates a natural number) is also set to be in the non-light emitting state in a sub-field after the i^{th} sub-field.

4. The driving method according to claim 3, wherein a pixel emitting the light in j+1 sub-fields implements a grayscale higher than that of a pixel emitting the light in j sub-fields (j indicates a natural number).

5. The driving method according to claim 1, wherein the light emitting periods of each of the sub-fields in the frame period are set to be different.

6. The driving method according to claim 5, wherein a light emitting period of an i^{th} sub-field (i indicates a natural number) is set to be longer than that of an i^{th}−1 sub-field.

7. The driving method according to claim 1, wherein the voltage of the data signals supplied to the sub-fields are set so that a plurality of grayscales are implemented in each of the sub-fields.

8. The driving method according to claim 1, wherein the voltage of the initialization power supply is set to be lower than the voltage of the data signal.

9. An organic light emitting display device driven in each sub-field divided from one frame, the organic light emitting display device comprising:
a scan driving unit supplying scan signals to scan lines and light emitting control signals to light emitting control lines, respectively, in each of the sub-fields;
a control driving unit supplying control signals to control lines only during an initialization period of a first sub-field of the frame;
a data driving unit supplying data signals to data lines so as to be synchronized with the scan signals in each of the sub-field; and
pixels positioned at intersection portions between the scan lines, the data lines and the control lines.

10. The organic light emitting display device according to claim 9, wherein the data driving unit supplies a data signal having voltage higher than that of a data signal supplied in an i^{th} sub-field (i indicates a natural number) during an i^{th}−1 sub-field period.

11. The organic light emitting display device according to claim 9, wherein light emitting periods in which the pixels emit light are set to be different in each of the sub-fields.

12. The organic light emitting display device according to claim 11, wherein a light emitting period of an i^{th} sub-field (i indicates a natural number) is set to be longer than a light emitting period of an i^{th}−1 sub-field.

13. The organic light emitting display device according to claim 9, wherein the control driving unit supplies the control signal to an i^{th} control line before the scan signal is supplied to an i^{th} line (i indicates a natural number).

14. The organic light emitting display device according to claim 13, wherein the scan driving unit supplies the light emitting control signal to the i^{th} light emitting control line so as to be overlapped with the scan signal supplied to the i^{th} scan line and the control signal supplied to the i^{th} control line.

15. The organic light emitting display device according to claim 14, wherein each of the pixels positioned at an i^{th} horizontal line including:
an organic light emitting diode;
a first transistor controlling an amount of current flowing from a first power supply connected to a first electrode thereof to a second power supply via the organic light emitting diode, corresponding to voltage applied to a first node;
a second transistor connected between the first node and an initializing power supply and turned on when the control signal is supplied to the i^{th} control line;
a third transistor connected between the data line and the first electrode of the first transistor and turned on when the scan signal is supplied to the i^{th} scan line; and
a fourth transistor connected between a second electrode of the first transistor and the first node and turned on when the scan signal is supplied to the i^{th} scan line.

16. The organic light emitting display device according to claim 15, wherein each of the pixels positioned at the i^{th} horizontal line further includes:
a fifth transistor connected between the first electrode of the first transistor and the first power supply, and turned off when the light emitting control signal is supplied to the i^{th} light emitting control line and turned on in other cases; and
a sixth transistor connected between the second electrode of the first transistor and the organic light emitting display diode and turned off when the light emitting control signal is supplied to the i^{th} light emitting control line and turned on in other cases.
